(19) United States
(12) Patent Application Publication
(10) Pub. No.: US 2008/0086844 A1
(43) Pub. Date: Apr. 17, 2008

(54) KNOB FOR AN ELECTRONIC LOCKING CYLINDER

(76) Inventor: Herbert Meyerle, Maisach (DE)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/868,119

(22) Filed: Oct. 5, 2007

(30) Foreign Application Priority Data
Oct. 6, 2006 (EP) 06 02 1038.2

(51) Int. Cl. E05B 47/00

(52) U.S. Cl. 16/414; 70/277

(57) ABSTRACT

The present invention relates to a knob particularly for an electronic locking cylinder as well as a method for mounting such a knob to an electronic locking cylinder. The knob according to the present invention comprises a first grip part which is deep drawn from metal and a second grip part wherein the first and second grip parts are coupled with each other to form the knob.

The present invention relates to a knob, particularly for an electronic locking cylinder as well as an electronic locking cylinder and a method for mounting such a knob to an electronic locking cylinder.

Typically, mortise locks according to DIN 18251 for doors are provided with mechanical locking cylinders according to DIN 18252. Such locking cylinders comprise a cylinder housing and a cylinder core inserted therein which can be rotated within the housing with a matching key and moves a lock bit (actuator) extending from the cylinder housing in order to lock or unlock the lock. There are different designs like profile cylinders, round cylinders, oval cylinder (see also DIN EN 1303). Nowadays, the locking cylinder is the core part of the security of lock and door.

The known mechanical locking cylinders leave open several desires in respect of security, design of locking structures and flexibility, since mechanical keys can be easily copied, locking structures which show which person is admitted to which door have to be structured in an essentially hierarchic manner and if a key got lost or the locking structure has to be modified the locking cylinders have to be exchanged entirely. In order to avoid the aforementioned problems electronic locking cylinders were suggested.

Electronic locking cylinders are known in the state of the art. Electronic locking cylinders are generally characterized in that they comprise an electronic coding, e.g., in form of electronic signals, instead of a mechanical coding of the keys. Instead of a mechanical key, here an “electronic key” in form of a transmitter or a transponder is used, which transmits the electric signals from the transponder to the locking cylinder by means of electromagnetic waves. The signals are verified by means of an electronic means wherein said electronic means is mainly integrated in one or two knobs which are provided at a locking cylinder or a profile cylinder. The knob or the knobs serve(s) besides the accommodation of electronic components also as handle for operating the locking cylinder and its lock bit.

Thus, DE 198 51 308 discloses a locking cylinder having a cylinder housing which can be inserted into a door lock, a lock bit being rotatable relative to the housing for operating the locking means of the door lock, a handle at the inner side of the door for operating the lock bit and a handle at the outer side of the door for operating the lock bit provided that access permission has been determined. An access control electronic for verifying the access permission of a person requesting access is arranged within the handle door's inner side.

Electronic locking cylinders are available in form of single knob cylinders (half cylinder) or double knob cylinders. For mounting or dismounting an electronic single knob cylinder the knob, according to the manufacturer and its structure, is rotated by some degrees so that the lock bit does not extend from the cylinder housing or locking cylinder and that the locking cylinder can be inserted into the lock housing. The locking cylinder is fixed at the lock housing by a relatively long screw, the fastening screw. When mounting double knob cylinders, additionally one of the two knobs has to be removed in order to be able to insert the locking cylinder into the lock housing.

In some models, the knobs are fixed to the shaft of the locking cylinder by radially arranged hexagon socket set screws which are partially slightly modified. Generally, these can be easily removed by unauthorized persons using standard tools.

On the one hand, the electronic and/or battery(ies) accommodated within the knobs should be protected against unauthorized access as best as possible. On the other hand, experts should be able to open these knobs easily for replacing the batteries.

In some electronic locking cylinders the knobs are made of lathed metal, die cast or plastic. Knobs made of die cast often have relatively thick walls and are, thus, rather heavy. Knobs made of lathed metal can in fact be produced with thinner walls but such knobs are very expensive. Plastic knobs can be produced in a very inexpensive manner but plastic knobs do not provide the robustness of a metal knob. Furthermore, the end user acknowledges a metal knob as being more esthetic and valuable.

It is the object of the present invention to provide an improved knob, an improved electric locking cylinder and, preferably, to overcome the above mentioned disadvantages of the state of the art.

The object of the present invention is solved by the independent claims. The dependent claims describe further preferred embodiments and modifications of the present invention.

The present invention relates to a knob, particularly an electronic knob, as well as to an electric locking cylinder and a method for mounting such a knob to an electronic locking cylinder. The present invention additionally relates to a method for opening and closing a knob according to the present invention.

The rotatable knob for an electronic locking cylinder according to the present invention comprises a first grip part being deep drawn from metal and a second grip part wherein the first and second grip parts are coupled to each other to form the knob. The first grip part being preferably essentially cylindrical can be coupled to the second grip part in a detachable or undetachable manner. Preferably the two grip parts forming a knob which accommodates electronic means and/or battery(ies) are coupled in a detachable manner. According to a preferred embodiment a biasing means is provided which biases the second grip part against the first grip part in order to avoid a visible gap between these two parts when the two grip parts are coupled. Said embodiment of a knob is, e.g., advantageous for an inner knob particularly when the entire electronic is accommodated within the inner knob.

The two grip parts are preferably coupled to each other in an undetachable maimer if no electronic means or batteries are present within the knob. The first grip part can be coupled to the second grip part in an undetachable manner by means of a form-fit and/or frictionally engaged connection. Since in the case of a double cylinder at least one of the knobs should be removable it is advantageous if the removable knob is formed in such a manner that the two grip parts are undetachably coupled to each other. The removable knob can then be removed as “one piece”. Said embodiment is advantageous for an outer knob since it preferably does not comprise sensitive electronic components and/or a battery, Preferably the afore-discussed preferred embodiments for the inner and the outer knob are quite similar in that they comprise a similar coupling mechanism which is referred to as “first bayonet coupling” in the following.

A knob which can be manufactured easily but is still sturdy and esthetic can be achieved according to the present invention in that the first (front) grip part is deep drawn from stainless steel and brushed or polished. The first grip part can be used as high frequency antenna if a respective electric insulation is provided which provides the preferred advantage that the knob itself does not have to be passable for high frequencies and can, therefore, keep its metal esthetic. The second (rear) grip part is preferably of metal and can be manufactured, for example, by known casting methods. The first and/or second grip part can additionally be stabilized by a plastic inner lining wherein further functional elements can be provided. The plastic inner lining has the preferred advantage that the inner lining of the inner knob can form a part of a bayonet coupling. Additionally, flexible plastic elements can be provided which secure the batteries against displacements within the inner knob.

For an easy and nevertheless secure mounting of the knobs to an electronic locking cylinder at least a first grip part of the knob provides a (first) bayonet coupling having a structure that the first grip part can be arranged detachably to the second grip part of the knob or the remaining locking cylinder. In other words, in this embodiment in which the first grip part is undetachably fixed to the second grip part, the bayonet coupling is suitable that the knob can be coupled to or removed from the locking cylinder “entirely”, i.e., as basically “one piece”. In the embodiment in which the first grip part is detachably attached to the second grip part the (first) bayonet coupling enables the two grip parts to be detachably coupled to each other. In this embodiment, the bayonet coupling is preferably biased in order to prevent that a gap between the first and second grip part becomes visible in the coupled condition.

The (first) bayonet coupling comprises preferably at least one ring element being at least partially rotatable, said ring element being preferably arranged at the second grip part and being axially secured and which releases a cam element or which engages therewith after being rotated for locking. The ring element can preferably be made of spring steel.

The (first) bayonet coupling additionally comprises a locking element preferably with at least one, preferably two locking elements which only allow a rotating of the ring element after operating the locking mechanism. The locking mechanism can be configured in such a manner that it can be operated by a tool rotating the ring element. The locking mechanism can preferably be operated by a tool rotating the ring element according to the key-lock principle. Preferably, the ring element comprises first and second recesses in which the locking elements of the locking mechanism can snap in, i.e., the locking elements engage into the first recesses when the bayonet coupling is open and they engage into the second recesses when the bayonet coupling is closed whereby the opening of the coupling without a suitable tool is prevented or blocked. Preferably the ring element is biased by a strong resilience. The ring element can only be rotated when the ring element is lifted against the corresponding strong resilience at the locations of the locking elements, i.e., the ring element is lifted at the recesses in such a manner that the ring element can be rotated over the locking elements. The lifting of the ring elements over the locking elements is preferably effected automatically when the tool for rotating is applied and rotated. According to one embodiment the locking mechanism can be operated by cones, which are arranged at claws or projections of the tool whereby the claws are additionally provided for rotating the ring element, i.e., the ring element can be lifted over the single or multiple locking element(s) by means of the cone or cones at the tool.

According to a further embodiment the second grip part is provided as a recessed grip ring preferably having two recessed grips which further support the handling of the knobs. In the recessed grip(s), preferably in the recessed grip of the inner knob, additionally an electric push-button can be provided. An electric push-button at the inner knob, preferably at the recessed grip ring and further preferred within the recessed grip, couples the inner knob with the lock bit after the push-button has been pressed so that a user can rotate the lock bit from the inside. Thus, the locking cylinder can be unlocked without a transponder from the inside. The arranging of the push-button within the recessed grip of the inner knob has the advantage that the user intuitively operates the electric locking cylinder according to the present invention in the correct manner.

According to a further embodiment, the locking cylinder according to the present invention can also be configured in such a manner that the inner knob is permanently undetachably coupled to the lock bit i.e., the cylinder can always be unlocked without a transponder by simply rotating the inner knob. The embodiment without push-button or with an undetachable coupling between the inner knob and the lock bit is in fact more economical in the manufacturing, but the embodiment with the variable coupling between inner knob and lock bit (embodiment with push-button), however, provides advantages in view of the security against manipulation. Thus, for example, the coupling between inner knob and lock bit can be limited in time either after operating the push-button or the period of a coupling can be programmed by means of a software. The push-button can also serve for further control possibilities.

The invention also relates to an electronic locking cylinder having a knob of the above described kind, i.e. a single knob cylinder or a double knob cylinder. The electronic double knob cylinder preferred according to the present invention preferably comprises an inner knob which can be opened and an outer knob which can be removed from the locking cylinder. Preferably the locking cylinder is configured in such a manner that a first tool is suitable to only remove the outer knob and not to open the inner knob, and a second tool is suitable to remove the outer knob and to open the inner knob.

In the following, a preferred embodiment of the present invention will be described in detail by referring to the Figures:

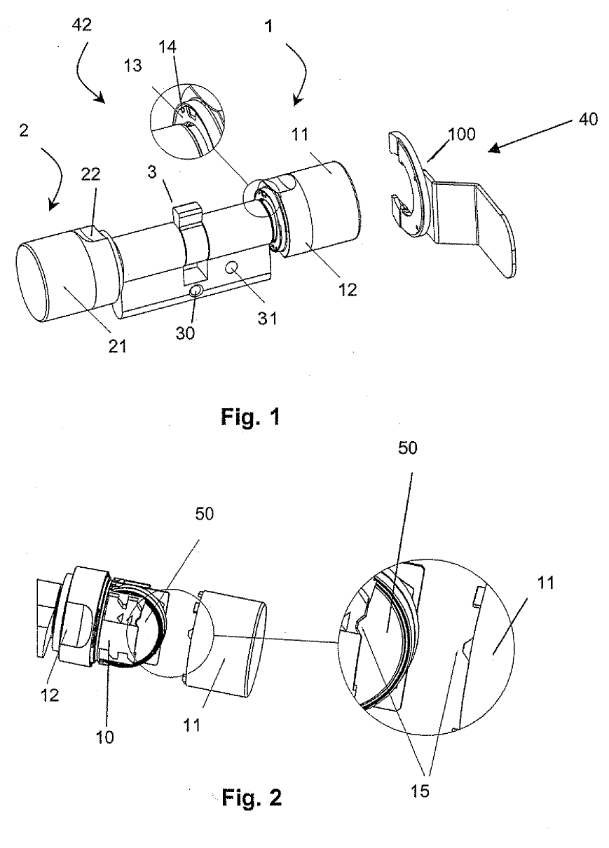

FIG. 1 shows a locking cylinder according to the present invention with knobs according to the present invention.

FIG. 2 shows in detail an inner knob according to the present invention.

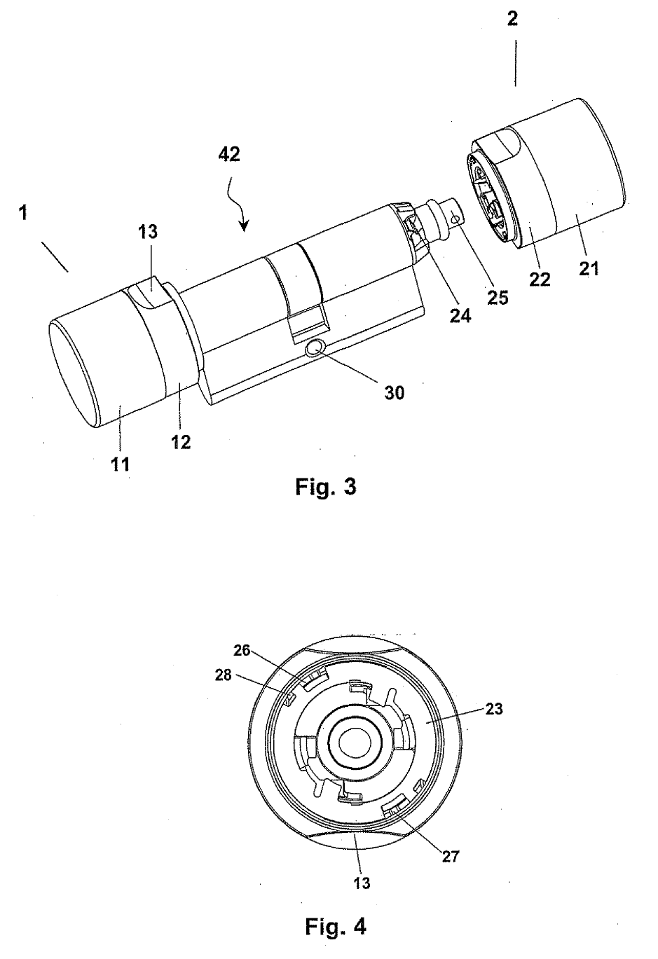

FIG. 3 shows a locking cylinder according to the present invention with the outer knob according to the present invention being removed.

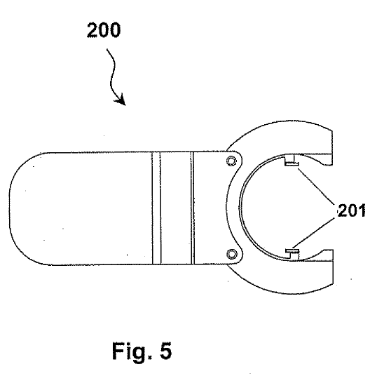

FIG. 4 shows in detail the ring element of an outer knob according to the present invention.

FIG. 5 shows in detail a tool according to the present invention.

FIG. 1 is a perspective view of a double knob cylinder 42 having an inner door knob 1 (inner knob) and an outer door knob 2 (outer knob) which are mounted to a locking cylinder. The locking cylinder comprises an actuator or lock bit 3 which is at least partially rotatable around the rotational or longitudinal axis of the locking cylinder, i.e. around the longitudinal axis extending through the locking cylinder and the door knobs 1 and 2.

The outer knob 2 as well as the inner knob I comprises a first grip part 21 or 11 and a second grip part 22 or 12. As can be taken from the Figure, the two grip parts, i.e. 1 with 12 and 21 with 22 are coupled with each other to form the respective knob (inner and outer knob, respectively).

The first grip part 11 or 21 is a cap according to the shown embodiment, the cap being preferably made of metal. The cap can be manufactured by means of usual methods like casting, die casting. However, it has become obvious that by deep drawing especially robust, economic and shapely caps can be manufactured. Therefore, the term “deep drawn cap” is used alternatively to the term “first grip part” in the following. A deep drawn cap made of stainless steel can be easily farther processed so that the deep drawn caps of preferred embodiments are additionally brushed and polished whereby a deep drawn cap is achieved having an appearance to be acknowledged as robust, elegant and valuable.

Preferably the second grip part, i.e., 12 or 22, comprises a recessed grip and is preferably configured as a ring so that the term “recessed grip ring” is alternatively used with regard to the specially shown embodiments.

In the shown embodiment, the first grip part 21 (deep drawn cap 21) of the outer knob 2 is undetachably coupled to the second grip part or recessed grip ring 22 while the first grip part 11 (deep drawn cap) of the inner knob I is coupled detachably with the second grip part or recessed grip ring 12.

The undetachable coupling of the first grip part 21 with the recess grip ring 22 is achieved, for example, by pressing the two parts into each other whereby a form-fit and/or frictionally engaged connection is achieved. Thus, the outer knob 2 can be mounted as “one piece” to the locking cylinder. This has the advantage that the locking cylinder can be easily inserted into the door lock by removing said outer knob 2. The outer knob 2 is preferably mounted to the locking cylinder with its rotational axis over the support shaft 25 by means of a (first) bayonet coupling (see FIG. 3). The first bayonet coupling comprises an at least partially rotatable ring element 23 (see FIG. 4) wherein the ring element 23 is preferably arranged at the recessed grip ring 22 and is axially secured to the recessed grip ring. The ring element 23 is preferably made of metal and preferably of spring steel. When the bayonet coupling is closed, the ring element 23 engages a cam element 24 at the support shaft 25, while, when the bayonet coupling is open, said cam element 24 is released so that the outer knob 2 can be removed from the locking cylinder. For mounting and demounting of the outer knob 2, a first tool (mounting tool 200) is preferably supplied. With said first mounting tool 200, the first bayonet coupling can be opened or closed, i.e., the ring element 23 can be rotated by the mounting tool 200 in such a manner that the engaging and releasing of the cam element 24 is achieved. According to the present invention, a second tool (mounting tool 100) can also be used for mounting and demounting the outer knob. Contrary to the first mounting tool 200, the second mounting tool 100 is configured in such a manner that also the inner knob I can be opened and closed in order to change the battery(ies).

In the embodiments shown in the Figures, the inner knob does not comprise an electric push-button. According to an embodiment, the inner knob can be coupled permanently with the lock bit, so that it is always possible to lock or unlock from the inside. According to a further embodiment, the inner knob, like the outer knob, can only be coupled to the lock bit after a successful authentification with the transponder, i.e., the locking cylinder can only be locked or unlocked from the outside as well as from the inside after the transponder has been operated.

According to a further embodiment, the inner knob 1, however, can additionally comprise an electric push-button. An electric bush-button at the inner knob 1, preferably at the recessed grip ring 12 and even more preferred within the recessed grip 13 couples the inner knob with the lock bit for a short time after the push-button has been pushed so that a user can rotate the lock bit from the inside. Preferably, the inner knob is coupled for 2 to 10 seconds after pressing the bush-button, for example for about 2 second, for example for 3 seconds or for 5 seconds. After and prior to the coupling, the inner knob is not coupled with the lock bit so that it is not possible to unlock from the inside without pressing the bush-button.

The mounting of a locking cylinder according to the present invention essentially comprises the following steps:

In order to prevent an accidental rotating of the ring element 23, the first bayonet coupling comprises a locking mechanism wherein the locking pins 27 engage into a first (larger) recess 26 in the open condition and the locking pins 27 snap into a second (smaller) recess 28 in the closed condition (FIG. 4). As can be taken from FIG. 4, two locking pins with corresponding recesses are preferred which are arranged diametrically to the axis of the ring element. The mounting tool 100 or 200 is applied to the outer knob 2 in such a manner that the two projections 101 or 201 of the mounting tool engage with the bayonet coupling of the knob. Particularly, the two projections 101 or 201 engage into the first recess 26 of the ring element 23 so that the ring element can be rotated with the mounting tool.

The outer knob 2 is fixedly held and the mounting tool 100 or 200 is carefully rotated by 30° in the anticlockwise direction (FIG. 4). The ring element 23 is rotated over the locking pins 27 (a clicking can be heard or felt) and simultaneously the ring element 23 is rotated over the cam element 24 at the locking cylinder so that the ring element no longer engages with the cam element. Preferably the applying and rotating of the mounting tool effects that the ring element 23 is lifted against a strong spring force at the locations of the locking elements and simultaneously with the lifting of the ring element a rotating is allowed. The lifting of the ring element is effected due to a specific configuration of the locking elements and the ring element, i.e. the locking elements or the ring element may have tapered portions by which a lifting of the ring element is automatically effected. Thus, the ring element can also be rotated without being lifted itself over the locking elements by the mounting tool.

The outer knob 2 can only be removed in “one piece”. The locking cylinder 42 can now be inserted without the outer knob from the inside towards the outside through the lock of the door and can be fixed with a fastening screw at the lock, said fastening screw engaging with the thread 30 of the locking cylinder. The outer knob 2 is again mounted to the support shaft 25 of the locking cylinder and the mounting tool 100 or 200 is applied to the outer knob 2 in such a manner that the two projections 101 or 201 engage into the ring element 23 of the bayonet coupling, i.e. into the first two recesses 26. The ring element 23 is closed again by a rotation of 30° to the right (in the clockwise direction, FIG. 4), i.e. the ring element is rotated over the cam element 24 in such a manner that said element is engaged. Again, a clicking can be heard when the ring element 23 is rotated over the locking pins 27. In the closed condition, the locking pins 27 engage into the second recess 28 (or the recesses) whereby an accidental rotating of the ring element is prevented.

In the shown embodiment, there are no electronic components arranged in the outer knob 2 while all electronic components, i.e. the evaluation electronic, the receiving antenna and the battery(ies) 50 are arranged within the inner knob 1. Preferably the inner knob 1 comprises an inner knob support element 10 which serves for receiving the evaluation electronic, the receiving antenna and the battery(ies) 50. Furthermore, the inner knob support element 10 serves to support or carry the inner recessed grip ring 12 and the deep drawn cap 11 of the inner knob.

Contrary to the outer knob 2, the inner knob 1 can, thus, not be removed in “one piece” from the locking cylinder. However, the inner knob 1 is nevertheless quite similar to the design of the outer knob 2 since the inner knob, toot comprises a recessed grip ring 12 and a deep drawn cap 11. The deep drawn cap 11 of the inner knob 1, like the one of the outer knob, is preferably made of deep drawn stainless steel. For esthetic reasons, the design of the inner cap is similar to the design of the outer cap. According to a preferred embodiment, the deep drawn cap 11 is stabilized by a plastic inner lining.

Preferably, the inner knob 1 comprises two bayonet couplings. A first bayonet coupling at the inner recessed grip ring 12 serves for attaching the recessed grip ring 12 to the inner knob support element 10 and for biasing the recessed grip ring element 12 and the deep drawn cap 11 against each other in order to prevent a gap to be easily recognizable there between.

The inner knob 1 according to the present invention furthermore comprises a second bayonet coupling which serves to fix the deep drawn cap 11 to the inner knob support element 10. Preferably, elements of the inner knob support element 10 engage in corresponding counter elements within the deep drawn cap 11 wherein said counter elements are preferably formed at the plastic inner lining of the deep drawn cap 11. The second bayonet coupling can be opened or closed by hand in this embodiment, i.e. without additional mounting tools. Since the inner knob should only be opened by expert personnel, a second mounting tool 100 is necessary for opening said knob, said mounting tool being suitable for operating the locking mechanism in the inner recessed grip ring.

The method for changing the battery(ies) 50 of the inner knob 1 according to the present invention essentially comprises the following steps:

Applying a second mounting tool 100 so that the two projections 101 of the mounting tool 100 engage in the first bayonet coupling of the inner knob. Like the outer knob 2 the first bayonet coupling of the inner recessed grip ring 12 also comprises a ring element 13 (FIG. 1) which can be rotated by the mounting tool 100 in such a manner that an engaging and releasing of a cam element 14 can be achieved. In this embodiment, however, the cam element 14 is connected to the inner recessed grip ring 12 so that a rotating of the ring element (opening of the first bayonet coupling) and thus a releasing of the cam element 14 results in that the inner recessed grip ring 12 can be displaced in axial direction. Preferably the inner recessed grip ring 12 is guided in such a manner that a displacement in the axial direction is only possible when the first bayonet coupling is open and a rotation of the recessed grip ring 12 is prevented. As in the bayonet coupling of the outer knob the ring element 13 comprises a locking mechanism with at least first and second recesses 16 and 18 (not shown but the recesses 16 and 18 are similar to the recesses 26 and 28 of FIG. 4) wherein the locking pins 17 are engaged with (snapped in) the second recesses 18 in the closed condition and in the open condition of the bayonet coupling the locking pins 17 together with the cam elements 14 are engaged with the first recess 16. As in the outer knob the ring element 13 with the first and second recesses 16 and 18 are rotated over the locking pins 17 for opening and closing. Contrary to the first mounting tool 200 which is usually supplied along with the locking cylinder, also the inner knob can be opened and closed with the second mounting tool 100, i.e., only with the second mounting tool, the locking mechanism of the inner knob can be locked and unlocked. Since the opening and closing of the inner knob should be reserved to experts only, the second mounting tool 100 is usually not supplied along with the double or single knob cylinder according to the present invention (contrary to the first mounting tool 200) so that this tool is only available to experts. The second mounting tool 100 comprises tapered portion at the protrusions 101, said tapered portions effecting the lifting of the ring element 13. When opening the inner knob, the ring element 13 is, thus, lifted against a strong spring force at the locations of the locking elements by the mounting tool 100 wherein simultaneously with the lifting of the ring element 13 a rotating is made possible. Here again, a clicking can be heard when opening or closing the bayonet coupling.

Fixedly holding the inner knob 1 and rotating the mounting tool 100 by 30° in the clockwise direction (here towards 40; FIG. 1). With this step the first bayonet coupling of the inner knob is opened. The ring element 13 is displaced in such a manner that the locking pins 17 together with the cam elements 14 engage into the recesses 18.

Pulling the recessed grip ring 12 rearwards (i.e., away from the deep drawn cap II) in the direction of the door so that the recessed grip ring 12 releases from the inner knob.

Rotating the inner cap 11 by about 10° in the anticlockwise direction and finally removing the inner cap 11 (see FIG. 2). Thereby the second bayonet coupling is opened.

Removing the batteries 50 from the holder.

Inserting the two new batteries 50, the positive poles showing to each other, into the holder.

Attaching the inner cap 11 corresponding to the projections 15 and rotating of the inner cap 11 by about 10° in order to fix the inner cap 11, i.e. closing of the second bayonet coupling.

Attaching the recessed grip ring 12 to the inner knob support element 10 so that the inner cap 11 is flush with the ring 12. The recessed grip ring 12 comprises recesses at its inner side which serve to receive the projections 15. Thus, the recessed grip ring 12 can only be displaced to flush with the deep drawn cap 11 when the deep drawn cap with the projections is rotated into the closed position of the second bayonet coupling. When the recessed grip ring 12 with the projection 15 is axially displaced the recessed grip ring 12 and the deep drawn cap are flush with each other. Additionally the recesses receiving the projections 15 prevent that the deep drawn cap can be rotated, i.e. the second bayonet coupling cannot be opened when the elements are flush with each other.

Applying the mounting tool 100 so that both projections engage into the recesses 16 of the ring element 13.

Rotating the ring element 13 by about 30° in anticlockwise direction whereby a closing of the first inner bayonet coupling is achieved.

The present invention allows for a preferred easy but secure mounting of the outer and inner knob. Features of the above mentioned various embodiments are embraced by the present invention.

The term “essentially” is to be understood in the present application in such a manner that two embodiments are covered at a time, namely the equivalent and the exact. For example, the term “essentially cylindrical” covers approximately cylindrical shapes as well as exactly cylindrical shapes.

1. Rotatable knob for a door lock as well as an electronic locking cylinder having
a) a first grip part being deep drawn from metal, and
b) a second grip part comprising recessed grips,
c) wherein the first and second grip part are coupled with each other to form the knob.

2. The knob according to claim 1 wherein the first grip part is a front part which is essentially cylindrical and the second grip part is a part arranged there behind.

3. The knob according to claim 1 wherein the first grip part and the second grip part are coupled detachably with each other.

4. The knob according to claim 2, wherein a biasing means is provided which biases the first grip part when coupled to the second grip part against the second grip part in order to avoid a visible gap between said two grip parts.

5. The knob according to claim 1 wherein the first grip part and the second grip part are coupled to each other by a form-fit and/or frictionally engaged connection.

6. The knob according to claim 1 wherein the first grip part is deep drawn from stainless steel and brushed or polished.

7. The knob according to claim 1 wherein the first grip part of the knob deep drawn from metal serves as antenna for high frequency radio.

8. Knob for a door lock like an electronic locking cylinder wherein at least the first grip part of the knob comprises a bayonet coupling in such a manner that the first grip part can be detachably arranged at a second grip part of the knob or the remaining door lock.

9. (canceled)

10. The knob according to claim 4, wherein the bayonet coupling additionally biases the first grip part when coupled to the second grip part against the second grip part to avoid a visible gap between them.

11. The knob according to claim 8 wherein the bayonet coupling comprises an at least partially rotatable ring element being preferably arranged at the first or second grip part and/or at the door lock, being axially secured, and releasing a cam element at the second or first grip part or/and door lock or, after being rotated, engaging said cam element.

12. The knob according to claim 11, wherein the ring element is made of spring steel.

13. The knob according to at least one of claim 11, wherein the bayonet coupling comprises at least two locking elements which only allow rotating the ring element when said ring element is lifted against a strong spring force at both portions.

14. The knob according to claim 13, wherein the locking elements are configured in such a manner that they are overcome automatically with the rotation by the corresponding mounting tool.

15. The knob according to claim 14, wherein the locking elements can be operated by a tool rotating the ring element, said tool working according to the key-lock principle.

16. The knob according to claim 14, wherein the locking element can be operated by a cone being arranged at the jaws of a tool wherein the jaws are additionally provided for rotating the ring element of the bayonet coupling.

17. The knob according to any one of claim 16, wherein an electric push-button is provided at the inner knob wherein the pushing of the push-button effects a temporary coupling of the inner knob with the lock bit.

18. Electronic locking cylinder having a knob according to claim 1.

19. Electronic locking cylinder, wherein the locking cylinder comprises an inner knob which can be opened and an outer knob which can be removed from the locking cylinder, wherein the locking cylinder is configured in such a manner that a first tool is suitable to only remove the outer knob but not to open the inner knob and a second tool is suitable to remove the outer knob and to open the inner knob.

20. Kit comprising an electronic locking cylinder according to claim 19 and a tool for opening the bayonet coupling.

21. The kit according to claim 20 comprising a programming means for programming the electronic locking cylinder.

22. Method for forming a knob particularly according to claim 1 comprising the steps of:
deep drawing a first grip part from metal,
providing a second grip part, and
coupling the two grip parts.

23. Usage of a knob according to claim 1, for an electric locking cylinder.
